(19) United States
(12) Patent Application Publication
(10) Pub. No.: US 2023/0070352 A1
(43) Pub. Date: Mar. 9, 2023

(54) DISPLAY APPARATUS AND METHOD OF DRIVING THE SAME

(71) Applicant: Samsung Display Co., Ltd., Yongin-si (KR)

(72) Inventors: YOUNGUK HWANG, Asan-si (KR); SEUNG-KYU LEE, Asan-si (KR); SUNGJIN KIM, Cheonan-si (KR); MYEONGHEE SEO, Hwaseong-si (KR)

(21) Appl. No.: 17/864,825

(22) Filed: Jul. 14, 2022

(30) Foreign Application Priority Data
Sep. 8, 2021 (KR) 10-2021-0119841

(51) Int. Cl. G09G 3/20; G09G 3/3233

(52) U.S. Cl. CPC G09G 3/2007; G09G 3/2096; G09G 3/3233; G09G 2320/0247; G09G 2300/0819; G09G 2320/0257; G09G 2300/0842; G09G 2310/0291; G09G 2330/028; G09G 2300/0426; G09G 2310/08; G09G 2320/0233; G09G 2320/0626; G09G 2330/021

(57) ABSTRACT

A display apparatus includes a display panel including a plurality of pixels, a gate driver which applies a bias gate signal to the pixels, a data driver which applies a data voltage to the pixels, an emission driver which applies an emission signal to the pixels, and a driving controller which controls the gate driver, the data driver, and the emission driver. The driving controller calculates a grayscale change region of input image data and a grayscale change level of the grayscale change region, determines a compensation region of the input image data based on the grayscale change region, determines a compensation grayscale voltage based on the grayscale change level, and compensates for the compensation region of the input image data based on the compensation grayscale voltage to generate output image data.

This application claims priority to Korean Patent Application No. 10-2021-0119841, filed on Sep. 8, 2021, and all the benefits accruing therefrom under 35 U.S.C. § 119, the content of which in its entirety is herein incorporated by reference.

### BACKGROUND

### 1. Field

Embodiments of the invention relate to a display apparatus and a method of driving the display apparatus. More particularly, embodiments of the invention relate to a display apparatus in which luminance change is compensated.

### 2. Description of the Related Art

Generally, a display apparatus may include a display panel and a display panel driver. The display panel may include gate lines, data lines, and pixels electrically connected to the gate lines and the data lines. The display panel driver may include a gate driver for providing a gate signal to the gate lines, a data driver for providing a data voltage to the data lines, and a driving controller for controlling the gate driver and the data driver.

When an image displayed on the display panel is a still image or the display panel operates in an always-on mode, the display apparatus may decrease a driving frequency to reduce power consumption.

### SUMMARY

In a display apparatus where a driving frequency is decreased, a flicker may occur due to a decrease of the driving frequency. In order to prevent the flicker, an anode initialization voltage may be applied to an anode electrode of a light emitting element at a frequency higher than the driving frequency. When the anode initialization voltage is applied at a frequency higher than the driving frequency, an image copy (or a ghost image) may be caused due to coupling between the data line and the anode electrode of the light emitting element.

Embodiments of the invention provide a display apparatus that prevents an image copy caused by a region in which a grayscale level of input image data changes rapidly.

Embodiments of the invention also provide a method of driving a display apparatus that prevents an image copy caused by a region in which a grayscale level of input image data changes rapidly.

According to embodiments of the invention, a display apparatus includes a display panel including a plurality of pixels, a gate driver which applies a bias gate signal to the pixels, a data driver which apply a data voltage to the pixels, an emission driver which applies an emission signal to the pixels, and a driving controller which controls the gate driver, the data driver, and the emission driver. In such an embodiment, the driving controller calculates a grayscale change region of input image data and a grayscale change level of the grayscale change region, determines a compensation region of the input image data based on the grayscale change region, determines a compensation grayscale voltage based on the grayscale change level, and compensates for the compensation region of the input image data based on the compensation grayscale voltage to generate output image data.

In an embodiment, the emission driver may receive dimming data from the driving controller to generate the emission signal, the compensation region may be determined based on the grayscale change region and the dimming data, and the compensation grayscale voltage may be determined based on the grayscale change level and the dimming data.

In an embodiment, the grayscale change region may include a change start part and a change end part, and the grayscale change level of the grayscale change region may be a change level of grayscale levels at the change start part and the change end part.

In an embodiment, each of the pixels may include a first transistor including a first terminal connected to a first node, a gate terminal connected to a second node, and a second terminal connected to a third node, a second transistor including a first terminal which receives the data voltage, a second terminal connected to the first node, and a gate terminal which receives a write gate signal, a third transistor including a first terminal connected to the third node, a second terminal connected to the second node, and a gate terminal which receives a compensation gate signal, a fourth transistor including a first terminal connected to the second node, a second terminal which receives an initialization voltage, and a gate terminal which receives an initialization gate signal, a fifth transistor including a first terminal which receives a first power voltage, a second terminal connected to the first node, and a gate terminal which receives an emission signal, a sixth transistor including a first terminal connected to the third node, a second terminal connected to a fourth node, and a gate terminal which receives the emission signal, a seventh transistor including a first terminal connected to the fourth node, a second terminal which receives an anode initialization voltage, and a gate terminal which receives the bias gate signal, an eighth transistor including a first terminal connected to the first node, a second terminal which receives a bias voltage, and a gate terminal which receives the bias gate signal, a storage capacitor including a first terminal which receives the first power voltage and a second terminal connected to the second node, and a light emitting element including a first electrode connected to the fourth node and a second electrode which receives a second power voltage lower than the first power voltage.

In an embodiment, a bias frequency of the bias gate signal and an emission frequency of the emission signal may be higher than a driving frequency of the display panel.

In an embodiment, the pixels may include a first pixel and a second pixel disposed on the compensation region, the first electrode of the light emitting element included in the first pixel may be not in a floating state at a timing of the change start part, and may be in the floating state at a timing of the change end part, and the first electrode of the light emitting element included in the second pixel may be in the floating state at the timing of the change start part, may be initialized between the timing of the change start part and the timing of the change end part, and may be in the floating state at the timing of the change end part.

In an embodiment, an absolute value of the compensation grayscale voltage may increase as a light emission time between the timing of the change end part and an anode initialization timing of the compensation region after the timing of the change end part increases.

In an embodiment, the driving controller further may include a buffer which stores at least a part of the input image data.

According to embodiments of the invention, a display apparatus includes a display panel including a plurality of pixels, a gate driver which applies a bias gate signal to the pixels, a data driver which applies a data voltage to the pixels, an emission driver which applies an emission signal to the pixels, a power voltage generator which applies an anode initialization voltage to the pixels, and a driving controller which control the gate driver, the data driver, and the emission driver. In such an embodiment, the driving controller calculates a grayscale change region of input image data and a grayscale change level of the grayscale change region, determines a compensation region of the input image data based on the grayscale change region, and determines a compensation initialization voltage based on the grayscale change level. In such an embodiment, the power voltage generator compensates for the anode initialization voltage based on the compensation initialization voltage to generate a compensation anode initialization voltage, and applies the compensation anode initialization voltage to the compensation region of the input image data.

In an embodiment, the compensation anode initialization voltage may be a sum of the anode initialization voltage and the compensation initialization voltage.

In an embodiment, the emission driver may receive dimming data from the driving controller to generate the emission signal, the compensation region may be determined based on the grayscale change region and the dimming data, and the compensation grayscale voltage may be determined based on the grayscale change level and the dimming data.

In an embodiment, the grayscale change region may include a change start part and a change end part, and the grayscale change level of the grayscale change region may be a change level of grayscale levels at the change start part and the change end part.

In an embodiment, each of the pixels may include a first transistor including a first terminal connected to a first node, a gate terminal connected to a second node, and a second terminal connected to a third node, a second transistor including a first terminal which receives the data voltage, a second terminal connected to the first node, and a gate terminal which receives a write gate signal, a third transistor including a first terminal connected to the third node, a second terminal connected to the second node, and a gate terminal which receives a compensation gate signal, a fourth transistor including a first terminal connected to the second node, a second terminal which receives an initialization voltage, and a gate terminal which receives an initialization gate signal, a fifth transistor including a first terminal which receives a first power voltage, a second terminal connected to the first node, and a gate terminal which receives an emission signal, a sixth transistor including a first terminal connected to the third node, a second terminal connected to a fourth node, and a gate terminal which receives the emission signal, a seventh transistor including a first terminal connected to the fourth node, a second terminal which receives an anode initialization voltage, and a gate terminal which receives the bias gate signal, an eighth transistor including a first terminal connected to the first node, a second terminal which receives a bias voltage, and a gate terminal which receives the bias gate signal, a storage capacitor including a first terminal which receives the first power voltage and a second terminal connected to the second node, and a light emitting element including a first electrode connected to the fourth node and a second electrode which receives a second power voltage lower than the first power voltage.

In an embodiment, a bias frequency of the bias gate signal and an emission frequency of the emission signal may be higher than a driving frequency of the display panel.

In an embodiment, the pixels may include a first pixel and a second pixel disposed on the compensation region, the first electrode of the light emitting element included in the first pixel may be not in a floating state at a timing of the change start part, and may be in the floating state at a timing of the change end part, and the first electrode of the light emitting element included in the second pixel may be in the floating state at the timing of the change start part, may be initialized between the timing of the change start part and the timing of the change end part, and may be in the floating state at the timing of the change end part.

In an embodiment, an absolute value of the compensation grayscale voltage may increase as a light emission time between the timing of the change end part and an anode initialization timing of the compensation region after the timing of the change end part increases.

In an embodiment, the driving controller may further include a buffer which stores at least a part of the input image data.

According to embodiments of the invention, a method of driving a display apparatus includes storing a first part of input image data, calculating a grayscale change region of the first part and a gray scale change level of the grayscale change region, determining a compensation region of a second part of the input image data different from the first part based on the grayscale change region, determining a compensation grayscale voltage based on the grayscale change level, and compensating for the compensation region of the second part based on the compensation grayscale voltage to generate output image data.

In an embodiment, the compensation region may be determined based on the grayscale change region and dimming data, and the compensation grayscale voltage may be determined based on the grayscale change level and the dimming data.

In an embodiment, the grayscale change region may include a change start part and a change end part, and the grayscale change level of the grayscale change region may be a change level of grayscale levels at the change start part and the change end part.

In embodiments of the invention, as described herein, the display apparatus may improve display quality of a display apparatus by preventing an image copy caused by a region in which a grayscale level of input image data changes rapidly.

In such embodiments, the display apparatus may compensate to prevent an image copy due to input image data by calculating a grayscale change region and a grayscale change level based on the input image data.

In such an embodiment, the display apparatus may perform compensate to prevent an image copy due to dimming data by calculating a grayscale change region and a grayscale change level based on the dimming data.

### BRIEF DESCRIPTION OF THE DRAWINGS

FIG. 1 is a block diagram illustrating a display apparatus according to an embodiment of the invention.

FIG. 2 is a circuit diagram illustrating an embodiment of pixels of the display apparatus of FIG. 1.

FIG. 3 is a block diagram illustrating an embodiment of a driving controller of the display apparatus of FIG. 1.

FIG. 4 is a timing diagram illustrating an embodiment of signals applied to pixels of the display apparatus of FIG. 1.

FIG. 5 is a timing diagram illustrating an embodiment of signals and data voltages applied to pixels of the display apparatus of FIG. 1.

FIG. 6 is a diagram illustrating an embodiment in which a display panel of the display apparatus of FIG. 1 displays an image.

FIG. 7 is a timing diagram illustrating signals and data voltages applied to pixels of a display apparatus according to an embodiment of the invention.

FIG. 8 is a block diagram illustrating a driving controller of a display apparatus according to an embodiment of the invention.

FIG. 9 is a block diagram illustrating a display apparatus according to an embodiment of the invention.

FIG. 10 is a block diagram illustrating an embodiment of a driving controller of the display apparatus of FIG. 9.

FIG. 11 is a timing diagram illustrating an embodiment of signals applied to pixels, a compensation anode initialization voltage, and data voltages applied to pixels of a display apparatus according to an embodiment of the invention.

FIG. 12 is a block diagram illustrating a driving controller of a display apparatus according to an embodiment of the invention.

FIG. 13 is a flowchart illustrating a method of driving a display apparatus according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

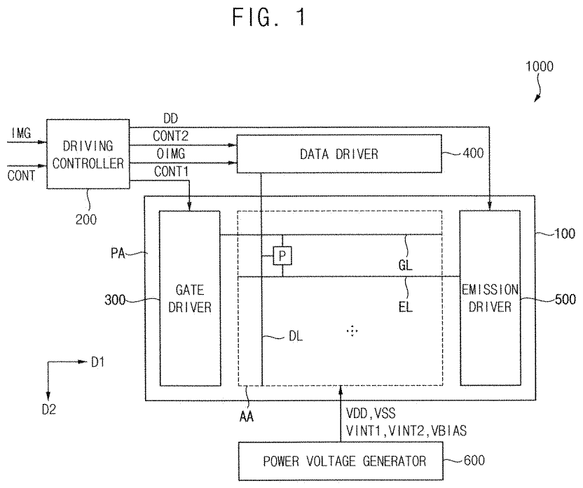

FIG. 1 is a block diagram illustrating a display apparatus 1000 according to an embodiment of the invention.

Referring to FIG. 1, an embodiment of the display apparatus 1000 may include a display panel 100, a driving controller 200, a gate driver 300, a data driver 400, an emission driver 500, and a power voltage generator 600. According to an embodiment, the driving controller 200 and the data driver 400 may be integrated into a single chip.

The display panel 100 has a display region AA on which an image is displayed and a peripheral region PA adjacent to the display region AA. According to an embodiment, the gate driver 300 may be integrated or integrally formed in the peripheral region PA of the display panel 100.

The display panel 100 may include a plurality of gate lines GL, a plurality of data lines DL, a plurality of emission lines EL and a plurality of pixels P electrically connected to the data lines DL, the gate lines GL, and the emission lines EL. The gate lines GL and the emission lines EL may extend in a first direction D1 and the data lines DL may extend in a second direction D2 crossing the first direction D1.

The driving controller 200 may receive input image data IMG and an input control signal CONT from an external apparatus (e.g., a graphic processing unit (“GPU”)). In an embodiment, for example, the input image data IMG may include red image data, green image data and blue image data. According to an embodiment, the input image data IMG may further include white image data. In an alternative embodiment, for example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, dimming data DD and a output image data OIMG based on the input image data IMG and the input control signal CONT.

The driving controller 200 may generate the first control signal CONT1 for controlling operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling operation of the data driver 400 based on the input control signal CONT and output the second control signal CONT2 to the data driver 400. The second control signal CONT2 may include a horizontal start signal and a load signal.

The driving controller 200 may generate the dimming data DD for controlling operation of the emission driver 500 based on the input control signal CONT and output the dimming data CONT2 to the data driver 400. The dimming data DD may include a vertical start signal and a emission clock signal.

The driving controller 200 may receive the input image data IMG and generate the output image data OIMG. The driving controller 200 may the output image data OIMG to the data driver 400.

The gate driver 300 may generate gate signals GW, GC, GI, and GB in response to the first control signal CONT1 input from the driving controller 200. The gate driver 300 may output the gate signals GW, GC, GI, and GB to the gate lines GL. In an embodiment, for example, the gate driver 300 may sequentially output the gate signals GW, GC, GI, and GB to the gate lines GL.

The data driver 400 may receive the second control signal CONT2 and the output image data OIMG from the driving controller 200. The data driver 400 may convert the output image data OIMG into a data voltage of an analog type. The data driver 400 may output the data voltage to the data lines DL.

The emission driver 500 may generate emission signal EM in response to the dimming data DD input from the driving controller 200. The emission driver 500 may output the emission signal EM to the gate lines GL. In an embodiment, for example, the gate driver 300 may sequentially output the emission signal EM to the emission lines EL.

The power voltage generator 600 may generate a first power voltage VDD, a second power voltage VSS, a initialization voltage VINT1, an anode initialization voltage VINT2, and a bias voltage VBIAS. The power voltage generator 600 may output the first power voltage VDD, the second power voltage VSS, the initialization voltage VINT1, the anode initialization voltage VINT2, and the bias voltage VBIAS to the pixels P of the display panel 100.

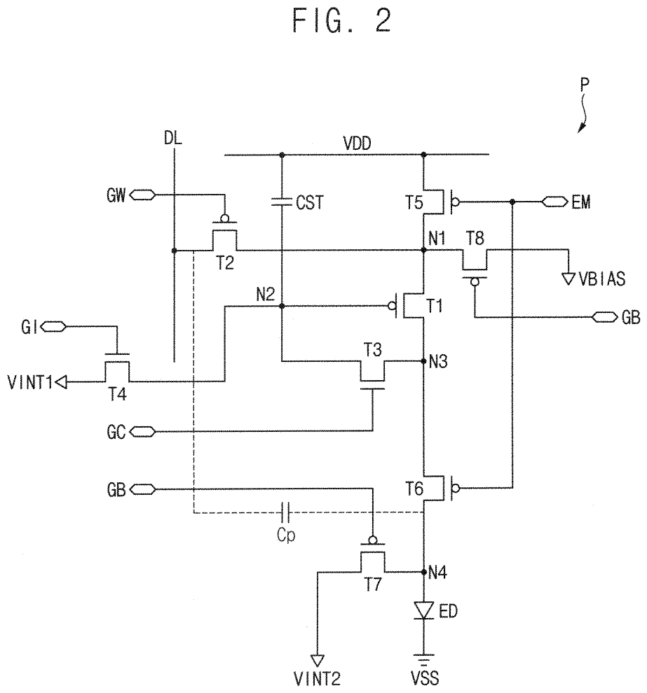

FIG. 2 is a circuit diagram illustrating an embodiment of the pixels P of the display apparatus 1000 of FIG. 1.

Referring to FIG. 2, an embodiment of each of the pixels P may include a first transistor T1, a second transistor T2, a third transistor T4, a fifth transistor T5, a sixth transistor, a seventh transistor T7, an eighth transistor T8, a storage capacitor CST, and a light emitting element ED.

The first transistor T1 may include a first terminal connected to the first node N1, a gate terminal connected to the second node N2, and a second terminal connected to the third node N3. The first transistor T1 may allow a driving current corresponding to a voltage of the second node N2 (i.e., a voltage stored in the storage capacitor CST) to flow to the light emitting element ED.

The second transistor T2 may include a first terminal connected to the data line DL (i.e., a terminal that receives the data voltage), a second terminal connected to the first node N1, and a gate terminal that receives a write gate signal GW. When the second transistor T2 is turned on in response to the write gate signal GW, the data voltage applied through the data line DL may be transferred to the first node N1.

The third transistor T3 may include a first terminal connected to the third node N3, a second terminal connected to the second node N2, and a gate terminal that receives a compensation gate signal GC. When the third transistor T3 is turned on in response to the compensation gate signal GC, the second terminal (i.e., the third node N3) of the first transistor T1 may be electrically connected to the gate terminal (i.e., the second node N2) of the first transistor T1. That is, when the third transistor T3 is turned on, the first transistor T1 is diode-connected, and accordingly, a threshold voltage of the first transistor T1 may be compensated.

The fourth transistor T4 may include a first terminal connected to the second node N2, a second terminal that receives the initialization voltage VINT1, and a gate terminal that receives an initialization gate signal GI. When the fourth transistor T4 is turned on in response to the initialization gate signal GI, the initialization voltage VINT1 may be transmitted to the second node N2. That is, when the fourth transistor T4 is turned on, the second node N2 (i.e., the gate terminal of the first transistor T1) is initialized to the initialization voltage VINT1, and accordingly, the first transistor T1 is in an on-bias state on-bias state (i.e., initialized to the on-bias state). In an embodiment, the initialization voltage VINT1 may be set to a voltage lower than the data voltage applied through the data line DL. In an embodiment, when the data voltage is transferred to the first node N1 when the second transistor T2 is turned on, the second node N2 is initialized to the initialization voltage VINT1 lower than the data voltage, and the first transistor T1 is turned on. Accordingly, the data voltage transferred to the first node N1 may be transferred to the second node N2 through the diode-connected first transistor T1. Accordingly, a voltage corresponding to the difference between the data voltage and the threshold voltage of the first transistor T1 may be applied to the second node N2, such that the storage capacitor CST may store a data voltage compensated by the threshold voltage of the first transistor T1.

The fifth transistor T5 may include a first terminal that receives the first power voltage VDD, a second terminal connected to the first node N1, and a gate terminal receiving the emission signal EM. When the fifth transistor T5 is turned on in response to the emission signal EM, the emitting element ED may be emitted by a driving current flowing through the first transistor T1 between the first power voltage VDD and the second power voltage VSS.

The sixth transistor T6 may include a first terminal connected to the third node N3, a second terminal connected to a fourth node N4, and a gate terminal that receives the emission signal EM. When the sixth transistor T6 is turned on in response to the emission signal EM, the light emitting element ED may be emitted by the driving current flowing through the first transistor T1 between the first power voltage VDD and the second power voltage VSS. In an embodiment, as described above, the fifth transistor T5 and the sixth transistor T6 may be turned on and off at the same time by receiving the emission signal EM in common, but not being limited thereto. Alternatively, the fifth transistor T5 and the sixth transistor T6 may receive emission signals independent of each other, respectively.

The seventh transistor T7 may include a first terminal connected to the fourth node N4, a second terminal that receives the anode initialization voltage VINT2, and a gate terminal that receives a bias gate signal GB. When the seventh transistor T7 is turned on in response to the bias gate signal GB, the anode initialization voltage VINT2 may be transmitted to the fourth node N4. That is, when the seventh transistor T7 is turned on, the fourth node N4 may be initialized to the anode initialization voltage VINT2. Specifically, when the anode initialization voltage VINT2 is applied to the first terminal of the light emitting element ED (i.e., an anode electrode of the light emitting element ED), a parasitic capacitor of the light emitting element ED is discharged, such that unintentional micro light emission may be prevented, thereby improving a black expression ability of the pixels P. In an embodiment, the initialization voltage VINT1 (i.e., a voltage that initializes the second node N2) and the anode initialization voltage VINT2 (i.e., a voltage that initializes the fourth node N4) may be set differently.

The eighth transistor T8 may include a first terminal connected to the first node N1, a second terminal that receives the bias voltage VBIAS, and a gate terminal that receives the bias gate signal GB. When the eighth transistor T8 is turned on in response to the bias gate signal GB, the bias voltage VBIAS may be transmitted to the first node N1. That is, when the eighth transistor T8 is turned on, the bias voltage VBIAS is applied to the first node N1. In addition, when the voltage of the first node N1 is varied to the bias voltage VBIAS, a characteristic curve of the first transistor T1 may be changed, such that luminance change due to a hysteresis of the first transistor T1 may be reduced.

The storage capacitor CST may include a first terminal that receives the first power voltage VDD and a second terminal connected to the second node N2. As described above, when the second transistor T2 is turned on, the data voltage transferred to the first node N1 is transferred to the second node N2 through the diode-connected first transistor T1, such that the storage capacitor CST may store the data voltage compensated by the threshold voltage of the first transistor T1.

The light emitting element ED may include a first terminal connected to the fourth node N4 and a second terminal that receives the second power voltage VSS lower than the first power voltage VDD. As described above, the light emitting element ED may emit light based on the driving current applied from the first transistor T1. In an embodiment, the light emitting element ED may be an organic light emitting diode including an organic light emitting layer. In an alternative embodiment, the light emitting element ED may be an inorganic light emitting element (e.g., quantum dot) including or formed of an inorganic material. According to an embodiment, the plurality of light emitting elements ED may be connected in parallel and/or in series between the second power voltage VSS and the fourth node N4.

In an embodiment, as described above, each of the pixels P may have a so-called 8T-1C structure including eight transistors T1 to T8 and one capacitor CST. In an embodiment, the third transistor T3 and the fourth transistor T4 may be implemented as an oxide thin film transistor. In such an embodiment, compared to a case in which the third transistor T3 is implemented as a low temperature poly-silicon (“LTPS”) thin film transistor, a leakage current flowing through the third transistor T3 may be reduced. In an embodiment, for example, as shown in FIG. 2, the third transistor T3 and the fourth transistor T4 are N-type metal-oxide-semiconductor (“NMOS”) transistors, and the first transistor T1, the second transistor T2, the fifth transistor T5, the sixth transistor T6, the seventh transistor T7, and the eighth transistor T8 may be P-type metal-oxide-semiconductor (“PMOS”) transistors, but not being limited thereto. Alternatively, at least one selected from the first transistor T1, the second transistor T2, the fifth transistor T5, the sixth transistor T6, the seventh transistor T7, and the eighth transistor T8 may be NMOS transistors, for example.

In an embodiment, when a driving time of a panel driving frame is a minimum driving time (i.e., when a driving frequency of the display panel 100 is a maximum driving frequency), each of the pixels P may perform one display scan operation (i.e., data write operation) and one self-scan operation. When the driving time of the panel driving frame is not the minimum driving time (i.e., when the driving frequency of the display panel 100 is lower than the maximum driving frequency), each of the pixels P may perform one display scan operation and at least two self-scan operations. As described above, the self-scan operation is an operation for changing a characteristics of the first transistor T1 (i.e., the driving transistor). In an embodiment, for example, when each of the pixels P performs a data write operation, the write gate signal GW may have an activation period. In an embodiment, within the inactive period of the emission signal EM, the write gate signal GW may be activated, the initialization gate signal GI may be activated, the compensation gate signal GC is activated, and the bias gate signal GB may be activated. In such an embodiment, before an activation period of the compensation gate signal GC, the bias gate signal GB may be activated. In an embodiment, within an activation period of the compensation gate signal GC, the initialization gate signal GI and the write gate signal GW may be sequentially activated. In an embodiment, when an inactivation period of the emission signal EM starts, a reset-bias operation may be performed in an activation period of the bias gate signal GB. In such an embodiment, in a state in which the driving current does not flow in the light emitting element ED when the fifth transistor T5 and the sixth transistor T6 are turned off, the seventh transistor T7 is turned on, such that the anode initialization voltage VINT2 is applied to the fourth node N4. Then, the eighth transistor T8 may be turned on such that the bias voltage VBIAS may be applied to the first node N1. Thereafter, an initialization operation may be performed in an activation period of the initialization gate signal GI. That is, since the fourth transistor T4 is turned on in the activation period of the initialization gate signal GI, the initialization voltage VINT1 may be applied to the second node N2. Next, a threshold voltage compensation and the data write operation may be performed in the activation period of the compensation gate signal GC and an activation period of the write gate signal GW. That is, since the third transistor T3 is turned on in the activation period of the compensation control signal GC, the second transistor T2 is turned on in the activation period of the write gate signal GW, and the first transistor T1 is turned on by initializing the second node N2 to the initialization voltage VINT1 lower than the data voltage, the data voltage compensated by the threshold voltage of the first transistor T1 may be stored to the storage capacitor CST. Thereafter, a light emitting operation may be performed in an activation period of the emission signal EM. That is, when the fifth transistor T5 and the sixth transistor T6 are turned on in the activation period of the emission signal EM, the driving current may flow through the light emitting element ED, such that the light emitting element ED may emit light.

Each of the pixels P may include a parasitic capacitor Cp generated by a coupling between the first terminal (or data line DL) of the second transistor T2 and the first terminal of the light emitting element ED (i.e., the anode electrode of the light emitting element ED). When the sixth transistor T6 and the seventh transistor T7 are turned off, the first terminal of the light emitting element ED (i.e., the anode electrode of the light emitting element ED) may be in a floating state. In addition, when the first terminal of the light emitting element ED (i.e., the anode electrode of the light emitting element ED) is in the floating state, a change of the data voltage applied to the data line DL may affect a voltage of the first terminal (i.e., the anode electrode of the light emitting element ED). As a result, the data write operation is performed by influencing a voltage of the first terminal of the light emitting element ED (i.e., the anode electrode of the light emitting element ED) of pixels P that are not performing the data write operation such that luminance change displayed by other pixels P that are not performing the data write operation may occur. Accordingly, image copy may appear as if the image was copied to a pixel P other than the pixel P intended to display the image due to the luminance change. A detailed description of the image copy will be described later.

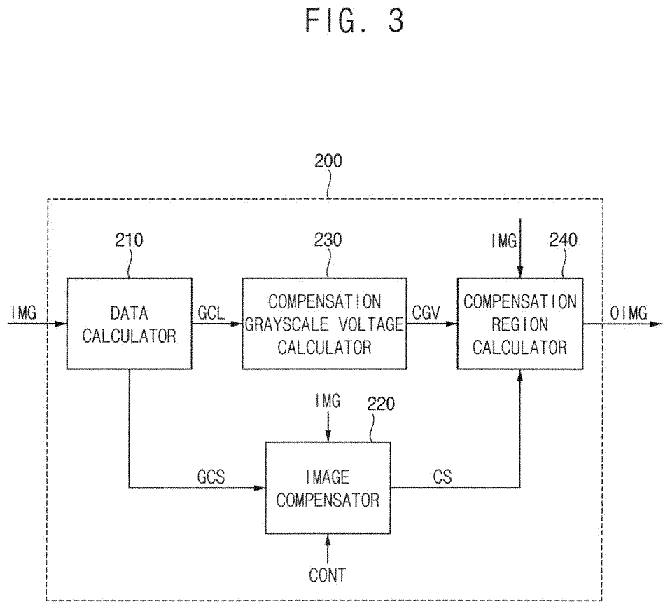

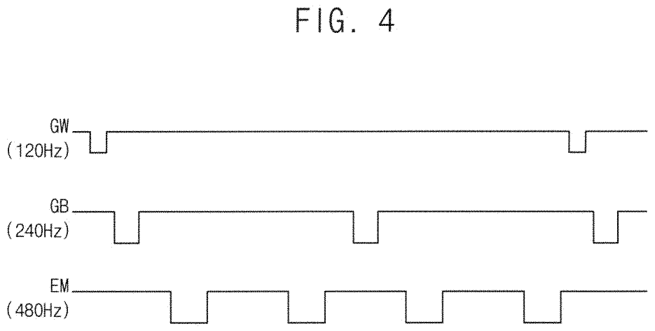

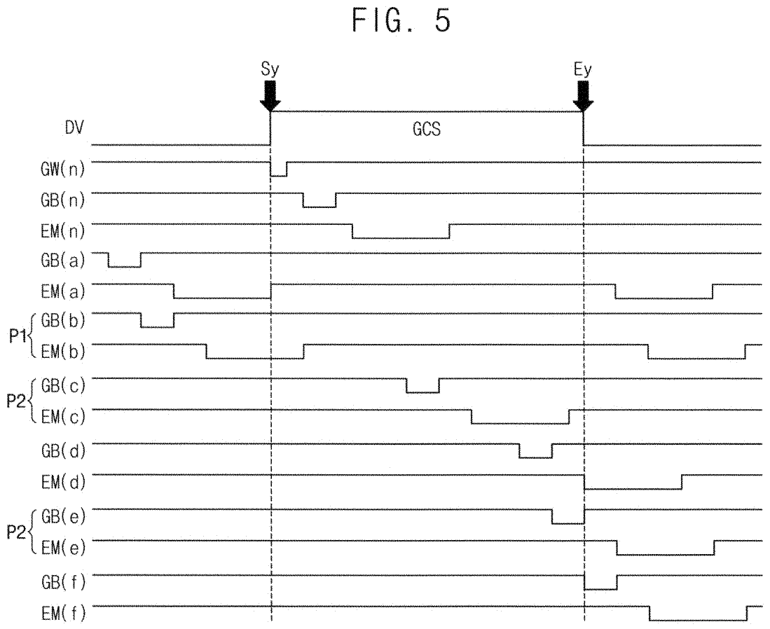

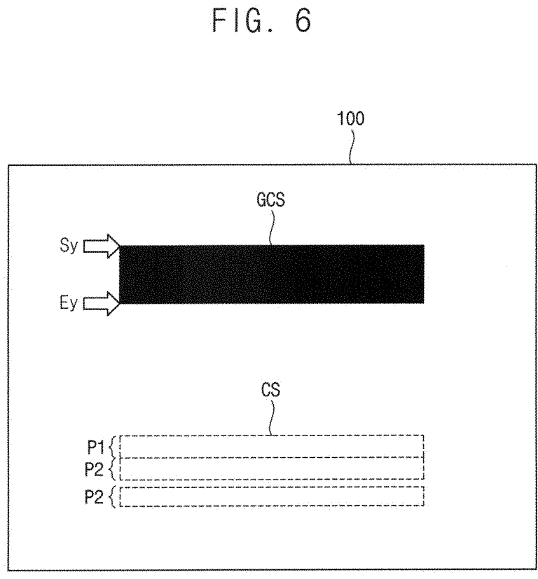

FIG. 3 is a block diagram illustrating an embodiment of the driving controller 200 of the display apparatus 1000 of FIG. 1, FIG. 4 is a timing diagram illustrating an embodiment of signals GW, GB, and EM applied to the pixels P of the display apparatus 1000 of FIG. 1, FIG. 5 is a timing diagram illustrating an embodiment of signals GW, GB, and EM and the data voltages applied to pixels P of the display apparatus 1000 of FIG. 1, and FIG. 6 is a diagram illustrating an embodiment in which the display panel 100 of the display apparatus 1000 of FIG. 1 displays an image. FIGS. 4 to 6 show an embodiment where a maximum driving frequency of the display panel 100 is 120 Hz, the display panel 100 is driven at the maximum driving frequency, a bias frequency of the bias gate signal GB is 240 Hz, and a emission frequency of the emission signal EM is 480 Hz.

Referring to FIGS. 1 to 6, in an embodiment, the driving controller 200 may calculate a grayscale change region GCS of the input image data IMG and a grayscale change level GCL of the grayscale change region GCS, determine a compensation region CS of the input image data IMG based on the grayscale change region GCS, determine a compensation grayscale voltage CGV based on the grayscale change level GCL, and compensate for the compensation region CS of the input image data IMG based on the compensation grayscale voltage CGV to generate the output image data OIMG.

The driving controller 200 may include a data calculator 210, a compensation region calculator 220, a compensation grayscale voltage calculator 230, and an image compensator 240.

The data calculator 210 may calculate the grayscale change region GCS of the input image data IMG and the grayscale change level GCL of the grayscale change region GCS. The grayscale change region GCS may mean a region in which the grayscale level of the input image data IMG is rapidly changed, e.g., greater than a predetermined change level. In an embodiment, for example, as shown in FIG. 6, an image of a white grayscale (e.g., 0 grayscale) is displayed around the gradation change region GCS, and a black grayscale (e.g., 255 grayscale) is displayed in the gradation change region GCS (i.e., a grayscale level of the input image data IMG is rapidly changed from the white grayscale to the black grayscale.). In an embodiment, as shown in FIGS. 5 and 6, the grayscale change region GCS may include a change start part Sy and a change end part Ey, the grayscale change level GCL of the grayscale change region GCS may be a change level of gray scale levels at the change start part Sy and the change end part Ey. The change start part Sy may be a part in which a grayscale is changed rapidly, and the change end part Ey may be a part in which the grayscale rapidly changed is back. In an embodiment, for example, a change level of the grayscale levels at the change start part Sy and the change end part Ey may be greater than a threshold change level. In an embodiment, for example, the threshold change level may be a level such that people can substantially perceive the image copy. The data calculator 210 may analyzes the input image data IMG to calculate the change start part Sy and the change end part Ey, and calculate a region between the change start part Sy and the change end part Ey as the grayscale change region GCS.

The compensation region calculator 220 may determine the compensation region CS based on the input image data IMG, the control signal CONT, and the grayscale change region GCS. In some embodiments, the compensation region CS may be determined based on the input image data IMG, the first control signal CONT1, the grayscale change region GCS, and the dimming data DD. In an embodiment, for example, the compensation region CS may be determined based on activation periods and activation timings of the gate signals GW, GC, GI, and GB and the emission signal EM. The compensation region CS may be a region in which the image copy is generated due to a sudden change in the grayscale level of the input image data IMG (i.e., grayscale level change at the change start part Sy and the change end part Ey).

Referring to FIGS. 2, and 4 to 6, the bias frequency of the bias gate signal GB and the emission frequency of the emission signal EM may be higher than the driving frequency of the display panel 100. In an embodiment, for example, the driving frequency of the display panel 100 may be 1 Hz to 120 Hz, the bias frequency may be 240 Hz, and the emission frequency may be 480 Hz. In an embodiment, for example, when the display panel 100 is driven at the maximum driving frequency (i.e., 120 Hz), the data write operation (i.e., the activation period of the write gate signal GW) is performed once, and the anode initialization operation (i.e., the activation period of the bias gate signal GB) may be performed twice. In such an embodiment, the anode initialization operation (i.e., the activation period of the bias gate signal GB) is performed more frequently, such that flicker of the image generated by a decrease of the driving frequency of the display panel 100 may be effectively prevented.

The pixels P may include a first pixel P1 and a second pixel P2 disposed on the compensation region CS. A first electrode of a light emitting element ED included in the first pixel P1 may not be in a floating state (i.e., the bias gate signal GB and the emission signal EM are inactivated) at a timing of the change start part Sy (i.e., a timing or a time point at which the data voltage DV rises), and may be in the floating state (i.e., the bias gate signal GB and the emission signal EM are inactivated) at a timing of the change end part Ey (i.e., a timing or a time point at which the data voltage DV falls). A first electrode of a light emitting element ED included in the second pixel P2 may be in the floating state (i.e., the bias gate signal GB and the emission signal EM are inactivated) at the timing of the change start part Sy (i.e., a timing at which the data voltage DV rises), may be initialized between the timing of the change start part Sy (i.e., a timing at which the data voltage DV rises) and the timing of the change end part Ey (i.e., a timing at which the data voltage DV falls), and is in the floating state (i.e., the bias gate signal GB and the emission signal EM are inactivated) at the timing of the change end part (i.e., a timing at which the data voltage DV falls). The timing of the change start part Sy may be a timing at which a data voltage corresponding to the change start part Sy is applied, and the timing the change end part Ey may be a timing at which a data voltage corresponding to the change end part Ey is applied.

In an embodiment, for example, referring to FIGS. 5 and 6, a first electrode of a light emitting element ED of pixels P included in a b-th pixel row connected to a same data line DL as pixels P to which the data voltage DV corresponding to the grayscale change region GCS is applied may not be in the floating state (i.e., the bias gate signal GB(b) and the emission signal EM(b) are inactivated) at the timing of the change start part Sy, and may be in the floating state (i.e., the bias gate signal GB(b) and the emission signal EM(b) are inactivated) at the timing of the change end part Ey. In such an embodiment, the pixels P included in the b-th pixel row may be the first pixel P1. When the data voltage DV of the pixels P included in the b-th pixel row increases, a voltage of the first electrode of the light emitting element ED of the pixels P included in the b-th pixel row may not be changed by a change of the data voltage DV. In such an embodiment, since the emission signal EM is activated, the change of the data voltage DV may not have a significant effect. In addition, when the data voltage DV of the pixels P included in the b-th pixel row decreases, a voltage of the first electrode of the light emitting element ED of the pixels P included in the b-th pixel row decreases. A decrease of the voltage of the first electrode of the light emitting element ED of the pixels P included in the b-th pixel row may reduce luminance displayed by the pixels P included in the b-th pixel row, and the image copy may be generated by a decrease of the luminance.

In an embodiment, for example, a first electrode of a light emitting element ED of pixels P included in a c-th pixel row connected to a same data line DL as pixels P to which the data voltage DV corresponding to the grayscale change region GCS is applied may not be in the floating state (i.e., the bias gate signal GB(c) and the emission signal EM(c) are inactivated) at the timing of the change start part Sy, may be initialized to the anode initialization voltage VINT2 between the timing of the change start part Sy and the change end part Ey, and may be in the floating state (i.e., the bias gate signal GB(c) and the emission signal EM(c) are inactivated) at the timing of the change end part Ey. In such an embodiment, the pixels P included in the c-th pixel row may be the second pixel P2. When the data voltage DV of the pixels P included in the c-th pixel row increases, a voltage of the first electrode of the light emitting element ED of the pixels P included in the c-th pixel row may be changed by a change of the data voltage DV. However, before the data voltage DV falls, a voltage of the first electrode of the light emitting element ED of the pixels P included in the c-th pixel row may be initialized to the anode initialization voltage VINT2. In addition, when the data voltage DV of the pixels P included in the c-th pixel row decreases, a voltage of the first electrode of the light emitting element ED of the pixels P included in the b-th pixel row decreases. A decrease of the voltage of the first electrode of the light emitting element ED of the pixels P included in the c-th pixel row may reduce luminance displayed by the pixels P included in the c-th pixel row, and the image copy may be generated by a decrease of the luminance.

In an embodiment, for example, a first electrode of a light emitting element ED of pixels P included in a e-th pixel row connected to a same data line DL as pixels P to which the data voltage DV corresponding to the grayscale change region GCS is applied may not be in the floating state (i.e., the bias gate signal GB(e) and the emission signal EM(e) are inactivated) at the timing of the change start part Sy, may be initialized to the anode initialization voltage VINT2 between the timing of the change start part Sy and the change end part Ey, and may be in the floating state (i.e., the bias gate signal GB(e) and the emission signal EM(e) are inactivated) at the timing of the change end part Ey. In such an embodiment, the pixels P included in the e-th pixel row may be the second pixel P2. When the data voltage DV of the pixels P included in the e-th pixel row increases, a voltage of the first electrode of the light emitting element ED of the pixels P included in the e-th pixel row may be changed by a change of the data voltage DV. However, before the data voltage DV falls, a voltage of the first electrode of the light emitting element ED of the pixels P included in the e-th pixel row may be initialized to the anode initialization voltage VINT2. In addition, when the data voltage DV of the pixels P included in the e-th pixel row decreases, a voltage of the first electrode of the light emitting element ED of the pixels P included in the e-th pixel row decreases. A decrease of the voltage of the first electrode of the light emitting element ED of the pixels P included in the e-th pixel row may reduce luminance displayed by the pixels P included in the e-th pixel row, and the image copy may be generated by a decrease of the luminance.

Accordingly, in an embodiment, the compensation region calculator 220 may determine the first pixel P1 and the second pixel P2 in which the luminance change may occur as the compensation region CS.

Referring back to FIG. 3, the compensation grayscale voltage calculator 230 may determine the compensation grayscale voltage CGV based on the grayscale change level GCL. As described above, a voltage of the first electrode of the light emitting element ED of the pixels P may be changed due to a rapid change of the data voltage DV. The change of the voltage of the first electrode of the light emitting element ED may be determined based on a value of the change of the data voltage DV (i.e., a value of change of the grayscale levels at the change start part Sy and the change end part Sy). Accordingly, the compensation grayscale voltage calculator 230 may determine the compensation grayscale voltage CGV by pre-calculating an increase or decrease value of the change of the voltage of the first electrode of the light emitting element ED based on the grayscale change level GCL.

The image compensator 240 may compensate for the compensation region CS of the input image data IMG based on the compensation grayscale voltage CGV to generate the output image data OIMG. In an embodiment, for example, when a voltage of the first electrode of the light emitting element ED of the first pixel P1 and a voltage of the first electrode of the second pixel P2 are decreased due to a change of the data voltage DV, the image compensator 240 may increase grayscales of a part of the input image data IMG corresponding to an image displayed in the first pixel P1 and the second pixel P2 so that the data voltage DV applied to the first pixel P1 and the second pixel P2 increases. In an embodiment, for example, when the voltage of the first electrode of the light emitting element ED of the first pixel P1 and the voltage of the first electrode of the second pixel P2 are increased due to the change of the data voltage DV, the image compensator 240 may decrease grayscales of the part of the input image data IMG corresponding to the image displayed in the first pixel P1 and the second pixel P2 so that the data voltage DV applied to the first pixel P1 and the second pixel P2 decreases. In an embodiment, for example, by compensating for the input image data IMG, a grayscale of the compensation region CS of the output image data OIMG may be determined based on a grayscale of the compensation region of the input image data IMG and a grayscale corresponding to the compensation grayscale voltage CGV. In such an embodiment, the compensation grayscale voltage calculator 230 may calculate a value of change of the voltage of the first electrode of the light emitting element ED of the pixels P based on the change of the data voltage DV to determine the compensation grayscale voltage CGV. In such an embodiment, the image compensator 240 may compensate for the input image data by a grayscale corresponding to the compensation grayscale voltage CGV to generate the output image data OIMG. In an embodiment, for example, when the luminance is reduced due to the image copy, the grayscale of the compensation region CS of the output image data OIMG may be a sum of the grayscale of the compensation region CS of the input image data IMG and a grayscale corresponding to an absolute value of the compensation grayscale voltage CGV (i.e., when the luminance is reduced, the compensation grayscale voltage CGV may be a positive real number). In an embodiment, for example, when the luminance is increased due to the image copy, the grayscale of the compensation region CS of the output image data OIMG may be a gray scale obtained by subtracting the grayscale corresponding to the absolute value of the compensation grayscale voltage CGV from the grayscale of the compensation region CS of the input image data IMG (i.e., when the luminance is reduced, the compensation grayscale voltage CGV may be a negative real number). As a result, the display apparatus 1000 may effectively prevent luminance change (i.e., the image copy) generated by coupling between the data line DL and the first electrode of the light emitting element ED.

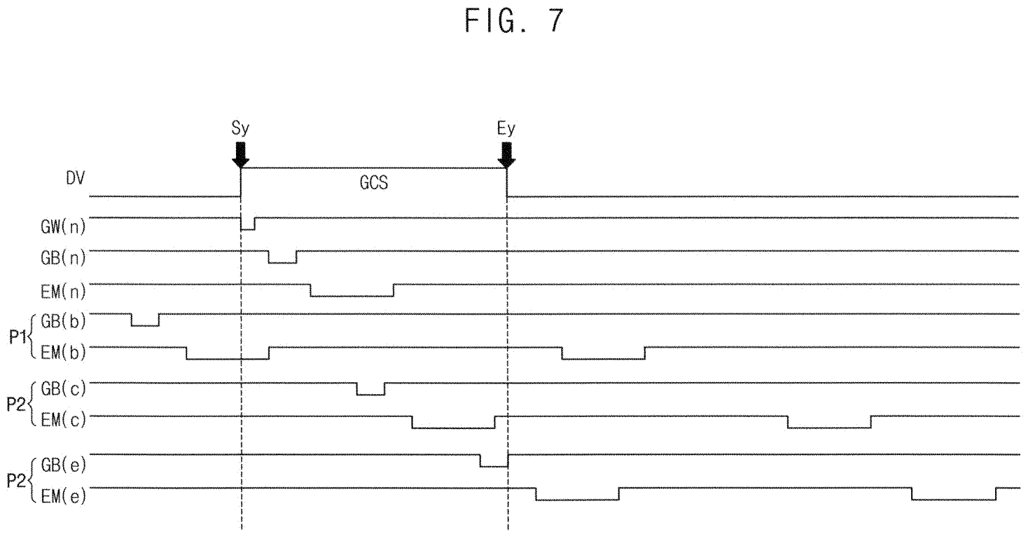

FIG. 7 is a timing diagram illustrating the signals GW, GB, and EM and the data voltages DV applied to the pixels P of a display apparatus according to an embodiment of the invention.

The display apparatus of FIG. 7 is substantially the same as the display apparatus 1000 of FIG. 1 except for a compensation grayscale voltage calculator. The same or like elements shown in FIG. 7 have been labeled with the same reference characters as used above to describe the embodiment of the display apparatus 1000 of FIG. 1, and any repetitive detailed description thereof will hereinafter be omitted or simplified.

Referring to FIGS. 1, 4, and 7, the compensation grayscale voltage calculator of FIG. 7 may determine the compensation grayscale voltage CGV based on the grayscale change level GCL and the dimming data DD. The absolute value of the compensation grayscale voltage CGV may increase as a light emission time (i.e., a length of the activation period of the emission signal EM) between the timing of the change end part Ey and an anode initialization timing (i.e., the bias gate signal GB is activated) of the compensation region GC after the timing of the change end part increases. In an embodiment, for example, as shown in FIG. 7, the bias gate signal GB(c) and the emission signal EM(c) of the pixels P included in the c-th pixel row have activation periods before the change end part Ey. The bias gate signal GB(e) of the pixels P included in the e-th pixel row has an activation period before the change end part Ey, and the emission signal EM(c) of the pixels P included in the e-th pixel row has not an activation period before the change end part Ey. Accordingly, a light emission time of the pixels P included the e-th pixel row between the timing of the change end part Ey and the anode initialization timing of the compensation region GC after the timing of the change end part is longer than a light emission time of the pixels P included the c-th pixel row between the timing of the change end part Ey and the anode initialization timing of the compensation region GC after the timing of the change end part. As a result, in the pixels P included in the e-th pixel row, luminance reduction effect due to a fall of the data voltage DV may be greater than that of the pixels P included in the c-th pixel row. Accordingly, the compensation grayscale voltage calculator may determine the absolute value of the compensation grayscale voltage CGV for the pixels P included in the e-th pixel row having a longer emission time to be greater than the absolute value of the compensation grayscale voltage CGV for the pixels P included in the c-th pixel row. In an embodiment, for example, when the luminance is reduced due to the change of the data voltage DV as shown in FIG. 7, the compensation grayscale voltage CGV may be a positive real number. As a result, a value of the compensation grayscale voltage CGV for the pixels P included in the e-th pixel row may be greater than a value of the compensation grayscale voltage CGV for the pixels P included in the c-th pixel row. In an embodiment, for example, unlike in FIG. 7, when the luminance increases due to the change of the data voltage DV, the compensation grayscale voltage CGV may be a negative real number. As a result, the value of the compensation grayscale voltage CGV for the pixels P included in the e-th pixel row may be less than the value of the compensation grayscale voltage CGV for the pixels P included in the c-th pixel row. In such an embodiment, the display device may compensate for the input image data IMG by varying the value of the compensation grayscale voltage CGV based on the dimming data DD (i.e., the activation period of the emission signal EM).

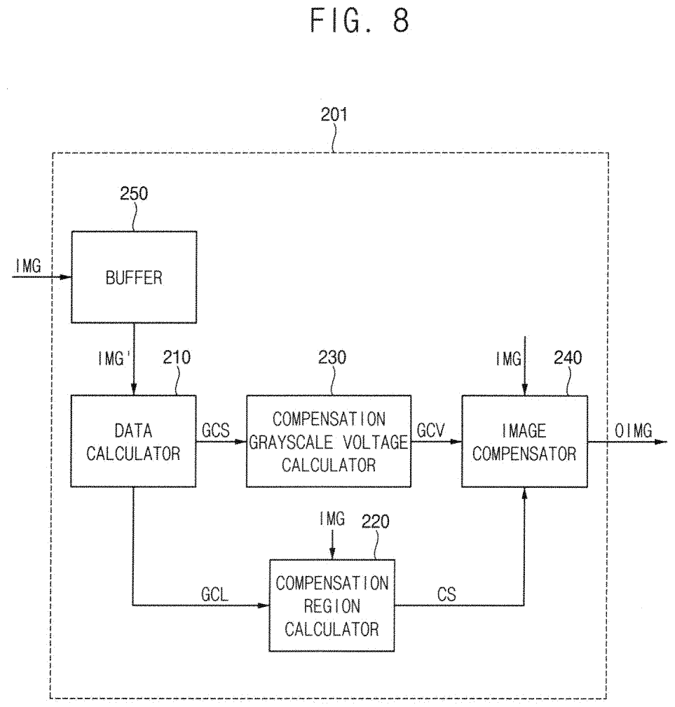

FIG. 8 is a block diagram illustrating a driving controller 201 of a display apparatus according to an embodiment of the invention.

The display apparatus of FIG. 8 is substantially the same as the display apparatus 1000 of FIGS. 1 and 3 except for the driving controller 201. The same or like elements shown in FIG. 8 have been labeled with the same reference characters as used above to describe the embodiment of the display apparatus 1000 of FIGS. 1 and 3, and any repetitive detailed description thereof will hereinafter be omitted or simplified.

Referring to FIGS. 4 and 8, an embodiment of the driving controller 201 may include a data calculator 210, a compensation region calculator 220, a compensation grayscale voltage calculator 230, an image compensator 240, and a buffer 250. The buffer 250 may store at least a part of the input image data IMG. In an embodiment, for example, the driving frequency of the display panel 100 may be 120 Hz, the bias frequency of the bias gate signal GB may be 240 Hz, and the emission frequency of the emission signal EM may be 480 Hz. In such an embodiment, the write gate signal GW may have one activation period during one frame, the bias gate signal GB may have two activation periods during one frame, and the emission signal EM may have four activation periods during one frame. Accordingly, the image copy may occur in the pixel rows in which the data write operation is performed after about ½ frame from the data write operation is performed in the grayscale change region GCS. Accordingly, the buffer 250 may store half of the input image data IMG′, and the data calculator 210 may receive the half IMG′ of the input image data from the buffer 250 to calculate the grayscale change region GCS and the grayscale change level GCL, and the image compensator 240 may compensate for the input image IMG based on the compensation region CS and the compensation grayscale voltage CGV determined based on the half IMG′ of the input image data. In an embodiment, for example, the image compensator 240 may compensate for a part of the input image IMG, which is not stored in the buffer 250, based on the compensation region CS and the compensation grayscale voltage CGV determined based on the half IMG′ of the input image data. Since the driving controller 201 includes the buffer 250, the data calculator 210 may analyze only the part IMG′ of the input image data. As a result, a time for the data calculator 210 to calculate the grayscale change region GCS and the grayscale change level GCL may be shortened, and an amount of data used to calculate the grayscale change region GCS and the grayscale change level GCL may be reduced.

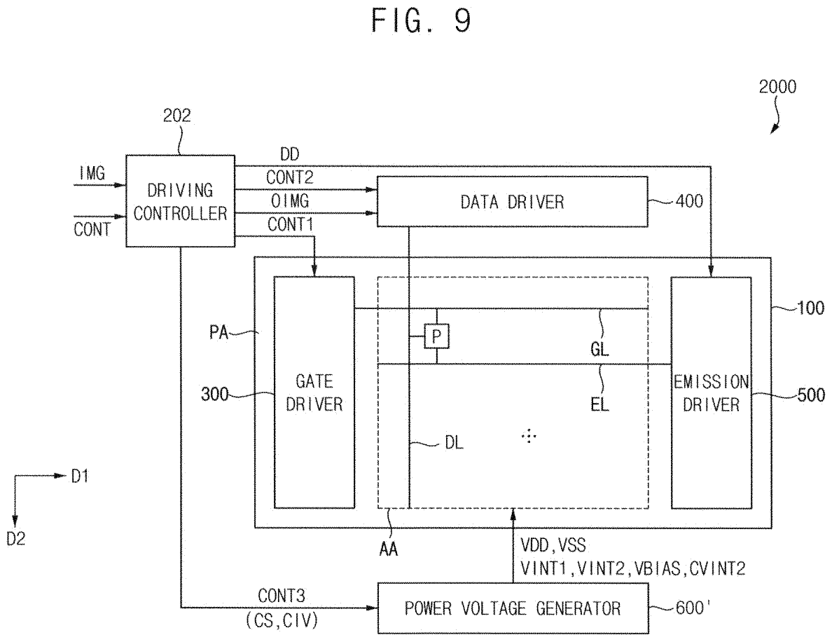

FIG. 9 is a block diagram illustrating a display apparatus 2000 according to an embodiment of the invention.

The display apparatus of FIG. 9 is substantially the same as the display apparatus 1000 of FIG. 1 except for the driving controller 202 and a poser voltage generator 600′. The same or like elements shown in FIG. 9 have been labeled with the same reference characters as used above to describe the embodiment of the display apparatus 1000 of FIG. 1, and any repetitive detailed description thereof will hereinafter be omitted or simplified.

Referring to FIG. 9, in an embodiment, the driving controller 202 may generate the first control signal CONT1, the second control signal CONT2, a third control signal CONT3, the dimming data DD and the output image data OIMG based on the input image data IMG and the input control signal CONT.

The driving controller 202 may generate the first control signal CONT1 for controlling operation of the gate driver 300 based on the input control signal CONT and output the first control signal CONT1 to the gate driver 300. The first control signal CONT1 may include a vertical start signal and a gate clock signal.

The driving controller 202 may generate the second control signal CONT2 for controlling operation of the data driver 400 based on the input control signal CONT and output the second control signal CONT2 to the data driver 400. The second control signal CONT2 may include a horizontal start signal and a load signal.

The driving controller 202 may generate the third control signal CONT3 for controlling operation of the power voltage generator 600′ based on the input control signal CONT and output the third control signal CONT3 to the power voltage generator 600′. The third control signal CONT3 may include the compensation region CS and a compensation initialization voltage CIV.

The driving controller 202 may generate the dimming data DD for controlling operation of the emission driver 500 based on the input control signal CONT and output the dimming data CONT2 to the data driver 400. The dimming data DD may include a vertical start signal and a emission clock signal.

The driving controller 202 may generate the output image data OIMG based on the input image data IMG and the input control signal CONT. The driving controller 202 may output the output image data OIMG to the data driver 400.

The power voltage generator 600 may generate the first power voltage VDD, the second power voltage VSS, the initialization voltage VINT1, the anode initialization voltage VINT2, a compensation anode initialization voltage CVINT2, and the bias voltage VBIAS. The power voltage generator 600 may output the first power voltage VDD, the second power voltage VSS, the initialization voltage VINT1, the anode initialization voltage VINT2, a compensation anode initialization voltage CVINT2, and the bias voltage VBIAS to the pixels P of the display panel 100.

The power voltage generator 600′ may compensate for the anode initialization voltage VINT2 based on the compensation initialization voltage CIV to generate the compensation anode initialization voltage CVINT2, and may apply the compensation anode initialization voltage CVINT2 to the compensation region CS of the input image data IMG. The compensation anode initialization voltage CVINT2 may be a sum of the anode initialization voltage VINT2 and the compensation initialization voltage CIV.

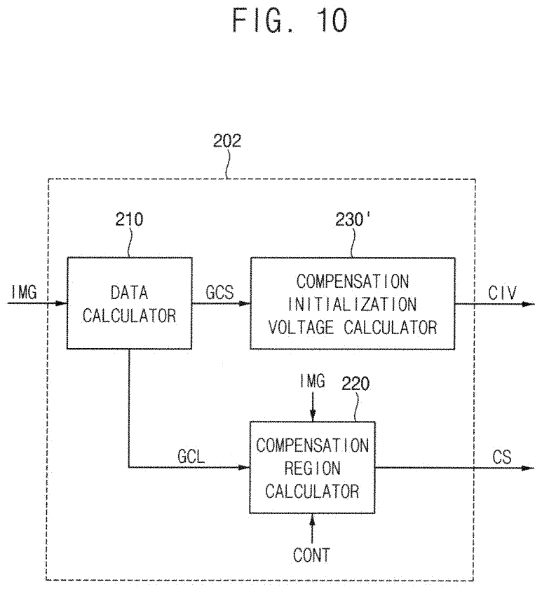

FIG. 10 is a block diagram illustrating an embodiment of a driving controller 202 of the display apparatus 2000 of FIG. 9. The data calculator 210 and the compensation region calculator 220 of the display apparatus 2000 of the FIG. 9 are substantially the same as the data calculator 210 and the compensation region calculator 220 of the display apparatus 1000 of FIG. 3. Thus, any repetitive detailed description thereof will hereinafter be omitted.

Referring to FIGS. 9 and 10, an embodiment of the driving controller 202 may include the data calculator 210, the compensation region calculator 220, and a compensation initialization voltage calculator 230′.

The compensation initialization voltage calculator 230′ may determine the compensation initialization voltage CIV based on the grayscale change level GCL. As described above, a voltage of the first electrode of the light emitting element ED of the pixels P may be changed due to a rapid change of the data voltage DV. The change of the voltage of the first electrode of the light emitting element ED may be determined based on a value of the change of the data voltage DV (i.e., a value of change of the grayscale levels at the change start part Sy and the change end part Sy). Accordingly, the compensation initialization voltage calculator 230′ may determine the compensation initialization voltage CIV by pre-calculating an increase or decrease value of the change of the voltage of the first electrode of the light emitting element ED based on the grayscale change level GCL. As the compensation anode initialization voltage CVINT2 is smaller (i.e., when the compensation anode initialization voltage CVINT2 is negative, an absolute value of the compensation anode initialization voltage CVINT2 is larger), luminance for the pixels P included in the compensation region CS may be reduced. Also, as the compensation anode initialization voltage CVINT2 increases (i.e., when the compensation anode initialization voltage CVINT2 is negative, the absolute value of the compensation anode initialization voltage CVINT2 decreases), luminance of the pixels included in the compensation region CS may be increased. According to an embodiment, a voltage of the compensation anode initialization voltage CVINT2 may be the sum of the anode initialization voltage VINT2 and the compensation initialization voltage CIV. According to an embodiment, when the voltage of the first electrode of the light emitting element ED of the pixels P decreases due to the image copy, the compensation initialization voltage CIV may be a positive real number. According to an embodiment, when the voltage of the first electrode of the light emitting element ED of the pixels P increases due to the image copy, the compensation initialization voltage CIV may be a negative real number. Also, the compensation initialization voltage CIV may increase as the grayscale change level GCL increases.

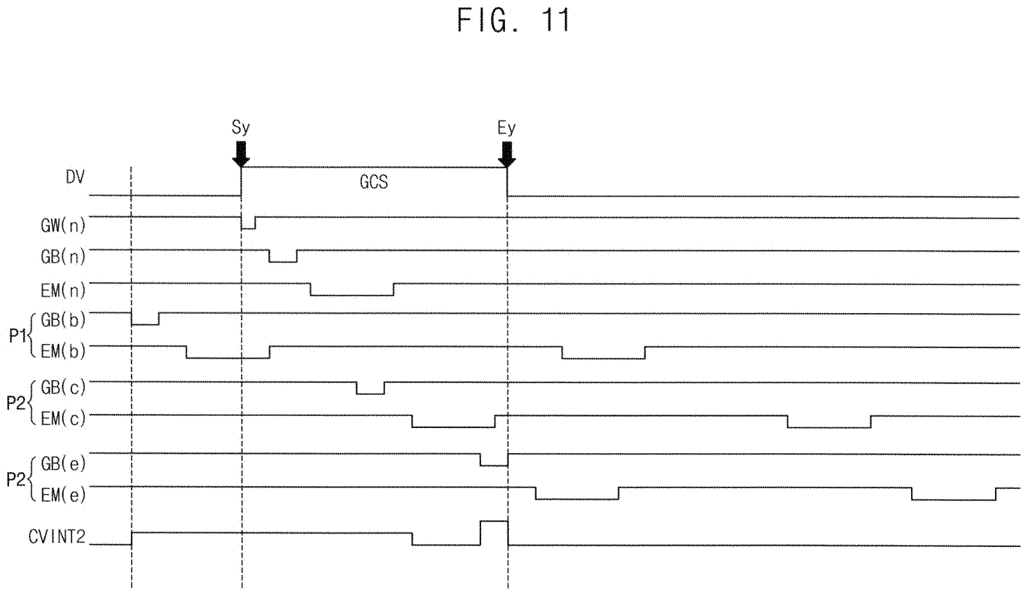

FIG. 11 is a timing diagram illustrating an embodiment of the signals GW, GB, and EM applied to the pixels P, the compensation anode initialization voltage CVINT2, and the data voltages DV applied to the pixels P of a display apparatus according to an embodiment of the invention.

The display apparatus of FIG. 11 is substantially the same as the display apparatus 1000 of FIGS. 1 and 5 except for a compensation initialization voltage calculator. The same or like elements shown in FIG. 11 have been labeled with the same reference characters as used above to describe the embodiment of the display apparatus 1000 of FIGS. 1 and 5, and any repetitive detailed description thereof will hereinafter be omitted or simplified.

Referring to FIGS. 9 and 11, the compensation initialization voltage calculator of FIG. 11 may determine the compensation initialization voltage CIV based on the grayscale change level GCL and the dimming data DD. The absolute value of the compensation initialization voltage CIV may increase as a light emission time (i.e., a length of the activation period of the emission signal EM) between the timing of the change end part Ey and an anode initialization timing (i.e., the bias gate signal GB is activated) of the compensation region GC after the timing of the change end part increases. In an embodiment, for example, as shown in FIG. 11, the bias gate signal GB(c) and the emission signal EM(c) of the pixels P included in the c-th pixel row have activation periods before the change end part Ey. In such an embodiment, the bias gate signal GB(e) of the pixels P included in the e-th pixel row has an activation period before the change end part Ey, and the emission signal EM(c) of the pixels P included in the e-th pixel row does not have an activation period before the change end part Ey. Accordingly, a light emission time of the pixels P included the e-th pixel row between the timing of the change end part Ey and the anode initialization timing of the compensation region GC after the timing of the change end part is longer than a light emission time of the pixels P included the c-th pixel row between the timing of the change end part Ey and the anode initialization timing of the compensation region GC after the timing of the change end part. As a result, in the pixels P included in the e-th pixel row, luminance reduction effect due to a fall of the data voltage DV may be greater than that of the pixels P included in the c-th pixel row. Accordingly, the compensation initialization voltage calculator may determine the absolute value of the compensation initialization voltage CIV for the pixels P included in the e-th pixel row having a longer emission time to be greater than the absolute value of the compensation initialization voltage CIV for the pixels P included in the c-th pixel row. In an embodiment, for example, when the luminance is reduced due to the change of the data voltage DV as shown in FIG. 11, the compensation initialization voltage CIV may be a positive real number. As a result, a value of the compensation initialization voltage CIV for the pixels P included in the e-th pixel row may be greater than a value of the compensation initialization voltage CIV for the pixels P included in the c-th pixel row. In an embodiment, for example, unlike in FIG. 11, when the luminance increases due to the change of the data voltage DV, the compensation initialization voltage CIV may be a negative real number. As a result, the value of the compensation initialization voltage CIV for the pixels P included in the e-th pixel row may be less than the value of the compensation initialization voltage CIV for the pixels P included in the c-th pixel row. In such an embodiment, the display device may compensate for the anode initialization voltage VINT2 by varying the value of the compensation initialization voltage CIV based on the dimming data DD (i.e., the activation period of the emission signal EM).

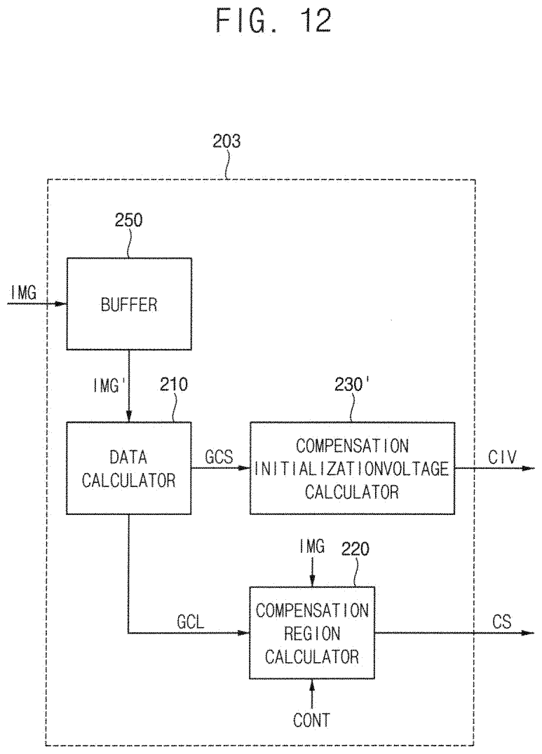

FIG. 12 is a block diagram illustrating a driving controller 203 of a display apparatus according to an embodiment of the invention.

The display apparatus of FIG. 12 is substantially the same as the display apparatus 1000 of FIGS. 1 and 3 except for the driving controller 203. The same or like elements shown in FIG. 12 have been labeled with the same reference characters as used above to describe the embodiment of the display apparatus 1000 of FIGS. 1 and 3, and any repetitive detailed description thereof will hereinafter be omitted or simplified.

Referring to FIG. 12, an embodiment of the driving controller 203 may include the data calculator 210, the compensation region calculator 220, the compensation initialization voltage calculator 230′, and a buffer 250. The buffer 250 may store at least a part of the input image data IMG. In an embodiment, for example, the driving frequency of the display panel 100 may be 120 Hz, the bias frequency of the bias gate signal GB may be 240 Hz, and the emission frequency of the emission signal EM may be 480 Hz. In such an embodiment, the write gate signal GW may have one activation period during one frame, the bias gate signal GB may have two activation periods during one frame, and the emission signal EM may have four activation periods during one frame. Accordingly, the image copy may occur in the pixel rows in which the data write operation is performed after about ½ frame from the data write operation is performed in the grayscale change region GCS. Accordingly, the buffer 250 may store half of the input image data IMG′, and the data calculator 210 may receive the half IMG′ of the input image data from the buffer 250 to calculate the grayscale change region GCS and the grayscale change level GCL, and the image compensator 240 may compensate for the input image IMG based on the compensation region CS and the compensation grayscale voltage CGV determined based on the half IMG′ of the input image data. In an embodiment, for example, the image compensator 240 may compensate for a part of the input image IMG, which is not stored in the buffer 250, based on the compensation region CS and the compensation grayscale voltage CGV determined based on the half IMG′ of the input image data. Since the driving controller 201 includes the buffer 250, the data calculator 210 may analyze only the part IMG′ of the input image data. As a result, a time for the data calculator 210 to calculate the grayscale change region GCS and the grayscale change level GCL may be shortened, and an amount of data used to calculate the grayscale change region GCS and the grayscale change level GCL may be reduced.

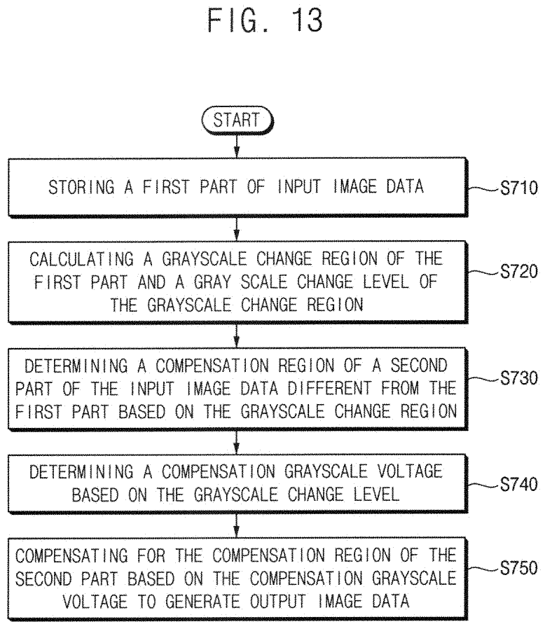

FIG. 13 is a flowchart illustrating a method of driving a display apparatus according to an embodiment of the invention.

Referring to FIG. 13, an embodiment of the method of driving a display apparatus may include storing a first part of input image data (S710), calculating a grayscale change region of the first part and a gray scale change level of the grayscale change region (S720), determining a compensation region of a second part of the input image data different from the first part based on the grayscale change region (S730), determining a compensation grayscale voltage based on the grayscale change level (S740), and compensating for the compensation region of the second part based on the compensation grayscale voltage to generate output image data (S750).

In an embodiment, the method of FIG. 13 may store a first part of input image data (S710) and the calculate a grayscale change region of the first part and a gray scale change level of the grayscale change region (S720). In an embodiment, for example, the driving frequency of the display panel 100 may be 120 Hz, the bias frequency of the bias gate signal may be 240 Hz, and the emission frequency of the emission signal may be 480 Hz. In such an embodiment, the write gate signal may have one activation period during one frame, the bias gate signal may have two activation periods during one frame, and the emission signal may have four activation periods during one frame. Accordingly, the image copy may occur in the pixel rows in which the data write operation is performed after about ½ frame from the data write operation is performed in the grayscale change region. Accordingly, in the method of FIG. 13, the first part, which is the part caused by the image copy, may be stored, and the grayscale change region and the grayscale change level in the first part may be calculated.

In an embodiment, the method of FIG. 13 may determine a compensation region of a second part of the input image data different from the first part based on the grayscale change region (S730). As described above, a part inducing the image copy may be the first part, and a part in which the image copy occurs may be the second part. Accordingly, the method of FIG. 13 may determine the compensation region in the second part.

In an embodiment, the method of FIG. 13 may determine a compensation grayscale voltage based on the grayscale change level (S740). The grayscale change region may mean a region in which the grayscale level of the input image data is rapidly changed. The grayscale change level of the grayscale change region may be a change level of grayscale levels at the change start part and the change end part. A effect of the image copy may increase as the grayscale variation level increases. Accordingly, in the method of FIG. 13, as the grayscale variation level increases, the compensation grayscale voltage may be determined as a larger value.

In an embodiment, the method of FIG. 13 may compensate for the compensation region of the second part based on the compensation grayscale voltage to generate output image data (S750). In an embodiment, for example, the output image data may be generated by compensating for the compensation region of the input image data by a grayscale level corresponding to the compensation grayscale level voltage.

Embodiments of the invention may be applied to any electronic apparatus including the display apparatus. In an embodiment, for example, the inventions may be applied to a television (“TV”), a digital TV, a three-dimensional (“3D”) TV, a mobile phone, a smart phone, a tablet computer, a virtual reality (“VR”) apparatus, a wearable electronic apparatus, a personal computer (“PC”), a home appliance, a laptop computer, a personal digital assistant (“PDA”), a portable multimedia player (“PMP”), a digital camera, a music player, a portable game console, a navigation apparatus, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel including a plurality of pixels;
a gate driver which applies a bias gate signal to the pixels;
a data driver which applies a data voltage to the pixels;
an emission driver which applies an emission signal to the pixels; and
a driving controller which controls the gate driver, the data driver, and the emission driver,
wherein the driving controller calculates a grayscale change region of input image data and a grayscale change level of the grayscale change region, determines a compensation region of the input image data based on the grayscale change region, determines a compensation grayscale voltage based on the grayscale change level, and compensates for the compensation region of the input image data based on the compensation grayscale voltage to generate output image data.

2. The display apparatus of claim 1,
wherein the emission driver receives dimming data from the driving controller to generate the emission signal,
wherein the compensation region is determined based on the grayscale change region and the dimming data, and
wherein the compensation grayscale voltage is determined based on the grayscale change level and the dimming data.

3. The display apparatus of claim 2,
wherein the grayscale change region includes a change start part and a change end part, and
wherein the grayscale change level of the grayscale change region is a change level of grayscale levels at the change start part and the change end part.

4. The display apparatus of claim 3, wherein each of the pixels includes:
a first transistor including a first terminal connected to a first node, a gate terminal connected to a second node, and a second terminal connected to a third node;
a second transistor including a first terminal which receives the data voltage, a second terminal connected to the first node, and a gate terminal which receives a write gate signal;
a third transistor including a first terminal connected to the third node, a second terminal connected to the second node, and a gate terminal which receives a compensation gate signal;
a fourth transistor including a first terminal connected to the second node, a second terminal which receives an initialization voltage, and a gate terminal which receives an initialization gate signal;
a fifth transistor including a first terminal which receives a first power voltage, a second terminal connected to the first node, and a gate terminal which receives an emission signal;
a sixth transistor including a first terminal connected to the third node, a second terminal connected to a fourth node, and a gate terminal which receives the emission signal;
a seventh transistor including a first terminal connected to the fourth node, a second terminal which receives an anode initialization voltage, and a gate terminal which receives the bias gate signal;
an eighth transistor including a first terminal connected to the first node, a second terminal which receives a bias voltage, and a gate terminal which receives the bias gate signal;
a storage capacitor including a first terminal which receives the first power voltage and a second terminal connected to the second node; and
a light emitting element including a first electrode connected to the fourth node and a second electrode which receives a second power voltage lower than the first power voltage.

5. The display apparatus of claim 4, wherein a bias frequency of the bias gate signal and an emission frequency of the emission signal are higher than a driving frequency of the display panel.

6. The display apparatus of claim 5,
wherein the pixels include a first pixel and a second pixel disposed on the compensation region,
wherein the first electrode of the light emitting element included in the first pixel is not in a floating state at a timing of the change start part, and is in the floating state at a timing of the change end part, and
wherein the first electrode of the light emitting element included in the second pixel is in the floating state at the timing of the change start part, is initialized between the timing of the change start part and the timing of the change end part, and is in the floating state at the timing of the change end part.

7. The display apparatus of claim 6, wherein an absolute value of the compensation grayscale voltage increases as a light emission time between the timing of the change end part and an anode initialization timing of the compensation region after the timing of the change end part increases.

8. The display apparatus of claim 1, wherein the driving controller further includes a buffer which stores at least a part of the input image data.

9. A display apparatus comprising:
a display panel including a plurality of pixels;
a gate driver which applies a bias gate signal to the pixels;
a data driver which applies a data voltage to the pixels;
an emission driver which applies an emission signal to the pixels;
a power voltage generator which applies an anode initialization voltage to the pixels; and
a driving controller which controls the gate driver, the data driver, and the emission driver,
wherein the driving controller calculates a grayscale change region of input image data and a grayscale change level of the grayscale change region, determines a compensation region of the input image data based on the grayscale change region, and determines a compensation initialization voltage based on the grayscale change level, and
wherein the power voltage generator compensates for the anode initialization voltage based on the compensation initialization voltage to generate a compensation anode initialization voltage, and applies the compensation anode initialization voltage to the compensation region of the input image data.

10. The display apparatus of claim 9, wherein the compensation anode initialization voltage is a sum of the anode initialization voltage and the compensation initialization voltage.

11. The display apparatus of claim 9,
wherein the emission driver receives dimming data from the driving controller to generate the emission signal,
wherein the compensation region is determined based on the grayscale change region and the dimming data, and
wherein the compensation grayscale voltage is determined based on the grayscale change level and the dimming data.

12. The display apparatus of claim 11,
wherein the grayscale change region includes a change start part and a change end part, and
wherein the grayscale change level of the grayscale change region is a change level of grayscale levels at the change start part and the change end part.

13. The display apparatus of claim 12, wherein each of the pixels includes:
a first transistor including a first terminal connected to a first node, a gate terminal connected to a second node, and a second terminal connected to a third node;
a second transistor including a first terminal which receives the data voltage, a second terminal connected to the first node, and a gate terminal which receives a write gate signal;
a third transistor including a first terminal connected to the third node, a second terminal connected to the second node, and a gate terminal which receives a compensation gate signal;
a fourth transistor including a first terminal connected to the second node, a second terminal which receives an initialization voltage, and a gate terminal which receives an initialization gate signal;
a fifth transistor including a first terminal which receives a first power voltage, a second terminal connected to the first node, and a gate terminal which receives an emission signal;
a sixth transistor including a first terminal connected to the third node, a second terminal connected to a fourth node, and a gate terminal which receives the emission signal;
a seventh transistor including a first terminal connected to the fourth node, a second terminal which receives an anode initialization voltage, and a gate terminal which receives the bias gate signal;
an eighth transistor including a first terminal connected to the first node, a second terminal which receives a bias voltage, and a gate terminal which receives the bias gate signal;
a storage capacitor including a first terminal which receives the first power voltage and a second terminal connected to the second node; and
a light emitting element including a first electrode connected to the fourth node and a second electrode which receives a second power voltage lower than the first power voltage.

14. The display apparatus of claim 13, wherein a bias frequency of the bias gate signal and an emission frequency of the emission signal are higher than a driving frequency of the display panel.

15. The display apparatus of claim 14,
wherein the pixels include a first pixel and a second pixel disposed on the compensation region,
wherein the first electrode of the light emitting element included in the first pixel is not in a floating state at a timing of the change start part, and is in the floating state at a timing of the change end part, and
wherein the first electrode of the light emitting element included in the second pixel is in the floating state at the timing of the change start part, is initialized between the timing of the change start part and the timing of the change end part, and is in the floating state at the timing of the change end part.

16. The display apparatus of claim 15, wherein an absolute value of the compensation grayscale voltage increases as a light emission time between the timing of the change end part and an anode initialization timing of the compensation region after the timing of the change end part increases.

17. The display apparatus of claim 9, wherein the driving controller further includes a buffer which stores at least a part of the input image data.

18. A method of driving a display apparatus, the method comprising:
storing a first part of input image data;
calculating a grayscale change region of the first part and a gray scale change level of the grayscale change region;
determining a compensation region of a second part of the input image data different from the first part based on the grayscale change region;
determining a compensation grayscale voltage based on the grayscale change level; and
compensating for the compensation region of the second part based on the compensation grayscale voltage to generate output image data.

19. The method of claim 18,
wherein the compensation region is determined based on the grayscale change region and dimming data; and
wherein the compensation grayscale voltage is determined based on the grayscale change level and the dimming data.

20. The method of claim 18,
wherein the grayscale change region includes a change start part and a change end part,
wherein the grayscale change level of the grayscale change region is a change level of grayscale levels at the change start part and the change end part.
